(19) United States
(12) Patent Application Publication
(10) Pub. No.: US 2014/0292478 A1
(43) Pub. Date: Oct. 2, 2014

(54) ACCESS MANAGEMENT

(71) Applicant: MUSIC GLUE LTD, London (GB)

(72) Inventor: Lee Matthew Henson, London (GB)

(21) Appl. No.: 14/356,091

(22) PCT Filed: Nov. 2, 2012
(86) PCT No.: PCT/GB12/00824

§ 371 Date: May 2, 2014

(30) Foreign Application Priority Data
Nov. 4, 2011 (GB) 1119087.3

(51) Int. Cl. G07C 9/00

(52) U.S. Cl. CPC G07C 9/00103
USPC 340/5.31; 340/5.2

(57) ABSTRACT

Access management method and apparatus comprising a ticket data input device configured to acquire ticket data from a presented ticket. Network interface configured to communicate with one or more other ticket verification devices on a network and data storage. Processor configured to receive ticket data from the one or more other ticket verification devices. Send received and/or acquired ticket data to the one or more other ticket verification devices. Store the acquired and/or received ticket data on the data storage. Verify the acquired ticket data from the presented ticket by comparing it with stored valid ticket data

### FIELD OF THE INVENTION

The present invention relates to a method and apparatus for managing access and for verifying tickets, in particular.

### BACKGROUND OF THE INVENTION

With the introduction of e-ticketing (print at home) into the live entertainment industry, the need to verify a ticket at the point of entry becomes more important than with traditional physical tickets because e-tickets are instantly replicable by the consumer. For smaller venues a list at the point of entry is adequate, with the door staff simply checking the ticket against the list and crossing the name off as required.

With sales of over 300 tickets, the time involved in doing this becomes problematic. Furthermore when you have an venue with multiple entry points a list is no longer suitable and an automated solution is required.

To date the live industry has tacked this problem by introducing expensive scanner and server equipment based on a 2 tier architecture, involving a master database server handling all requests from mobile devices operated by the door entry staff.

Specifically, the mobile device will scan the barcode from the e-ticket, send the scan result to the master server which in turn processes the barcode to verify if it is genuine and whether or not it has already entered the event, then return the result to the door entry staff who then receives feedback via a monitor on the mobile device.

The issues with this model are that there are 2 major points of failure that could cause the entire system to fail. Firstly, if the network fails the mobile devices are cut off from the master database and verification cannot occur. Secondly if the master server fails there is no verification process available at all. In both scenarios existing systems have a temporary failsafe whereby the door entry staff can still scan tickets and verify basic information contained within the 2D barcode however there is no cross checking in place and the risk of fraud is significant.

Furthermore, this solution is very expensive because it requires the following equipment in place:

Central server with power failure technology in place

A wi-fi based LAN capable of reaching all entry points

Mobile devices specifically designed to read barcodes and provide visual feedback to the user.

Therefore, there is required a method and system that overcomes these problems.

### SUMMARY OF THE INVENTION

Against this background and in accordance with a first aspect there is provided a method for managing access or verifying tickets comprising the steps of:

acquiring ticket data from a ticket presented to a ticket verification device;

receiving ticket data from one or more other ticket verification devices on a network;

sending received and/or acquired ticket data to the one or more other ticket verification devices on the network;

storing the acquired and/or received ticket data; and

verifying the acquired ticket data from the presented ticket by comparing it with stored valid ticket data.

The ticket data input device may be selected from the group consisting of: barcode reader, keyboard, camera, scanner, near field communication and RFID tag. Other data transfer interfaces and input devices may be used including those found on mobile devices such as cell phones.

The method described above may be implemented as a computer program comprising program instructions to operate a computer. The computer program may be stored on a computer-readable medium.

In accordance with a second aspect there is provided an access management or ticket verification apparatus comprising:

a ticket data input device configured to acquire ticket data from a presented ticket;

a network interface configured to communicate with one or more other ticket verification devices on a network;

data storage; and
a processor configured to:
   receive ticket data from the one or more other ticket verification devices;
   send received and/or acquired ticket data to the one or more other ticket verification devices;
   store the acquired and/or received ticket data on the data storage; and
   verify the acquired ticket data from the presented ticket by comparing it with stored valid ticket data.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings.

It should be noted that the figures are illustrated for simplicity and are not necessarily drawn to scale.

### DETAILED DESCRIPTION OF THE PREFERRED EMBODIMENTS

According to an embodiment master server may be removed completely by introducing a peer to peer type architecture whereby every mobile device acts as a server in it's own right. Furthermore devices are set up using ad-hoc LAN network technology whereby there is no need for a router to connect the devices, another point of failure that can cause total system failure.

Each mobile device used by door entry staff is not only reading the barcode but verifying it against the database of tickets and then also polling other machines on the network to keep all databases up, to date.

There are no points of failure that can disable the entire system and new devices can be added to the network and be completely up to date with the entire network within minutes. This allows for failures to occur with individual devices without any disruption to the process of getting customers into the event

The system is based on pushing information from 1 device to another and is based on a number of scheduled operations:

Discovery—Each device searches the network for the introduction of new devices and when discovered devices are added to the list of machines in operation and therefore which devices it must synchronise with.

Standard Update—At a frequency set by the user (typically 5 seconds) each device will send all event data within a set timescale (typically 10 seconds) to all machines on it's immediate network. The recipient will then merge events into it's local database.

Major Update—When a machine is added to a network or at the discretion of the user or at a predefined frequency (default is 30 minutes) a device will send all events to all devices on it's immediate network, with a complete merge of all data.

The solution costs a fraction of the cost of the traditional:

Uses standard laptops and netbooks

There is no central server

There is no need for a router although works with a router also.

There are no expensive portable scanner devices.

Under certain implementations, more than 1 person may enter per ticket. For example, a ticket may be bought for 6 people and all is requited is to bring 1 e-ticket to an event. Now, if only 4 people turn up, we can register or record that 2 more are still to come and be able to enter using the particular ticket data. This information may be sent out across the network to all ticket verification devices. When the final 2 friends arrive, all entry points are ready to admit 2 people only from the ticket. Any further presenters of the ticket information will result in rejection.

As will be appreciated by the skilled person, details of the above embodiment may be varied without departing from the scope of the present invention, as defined by the appended claims.

Whilst the system and method have been described using the example of tickets for events and verifying these types of tickets for entry by people to these events, other types of access management are envisaged. For example, the system and method may be used for inventory management or other similar applications. In such examples, the ticket data may relate to access to items within an inventory or access to a store or warehouse rather than entry to events.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

### KEY TO DRAWINGS

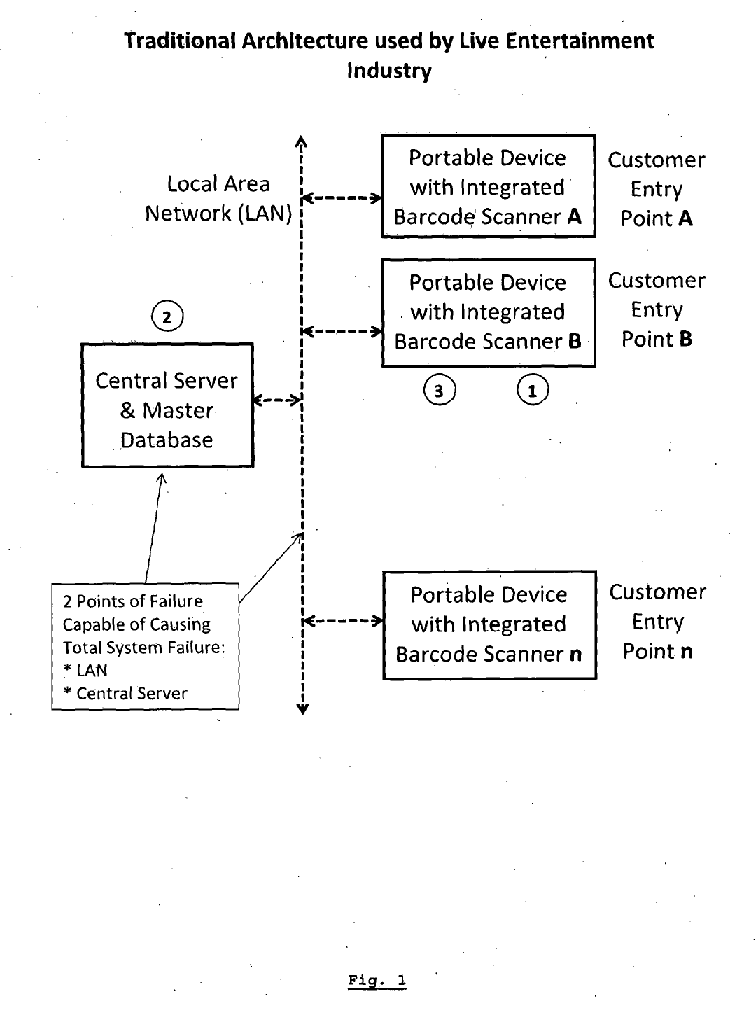

FIG. 1

\textcircled{1} A successful scan from barcode scanner is sent from portable device to central server via LAN;

\textcircled{2} The server verifies the ticket and sends a response back to portable device (marked at point of FIG. 1);

\textcircled{3} A portable device receives response from server and provides feedback to user (marked at point of FIG. 1). There are 2 points of failure capable of causing total system failure (marked in FIG. 1):
LAN
Central Server

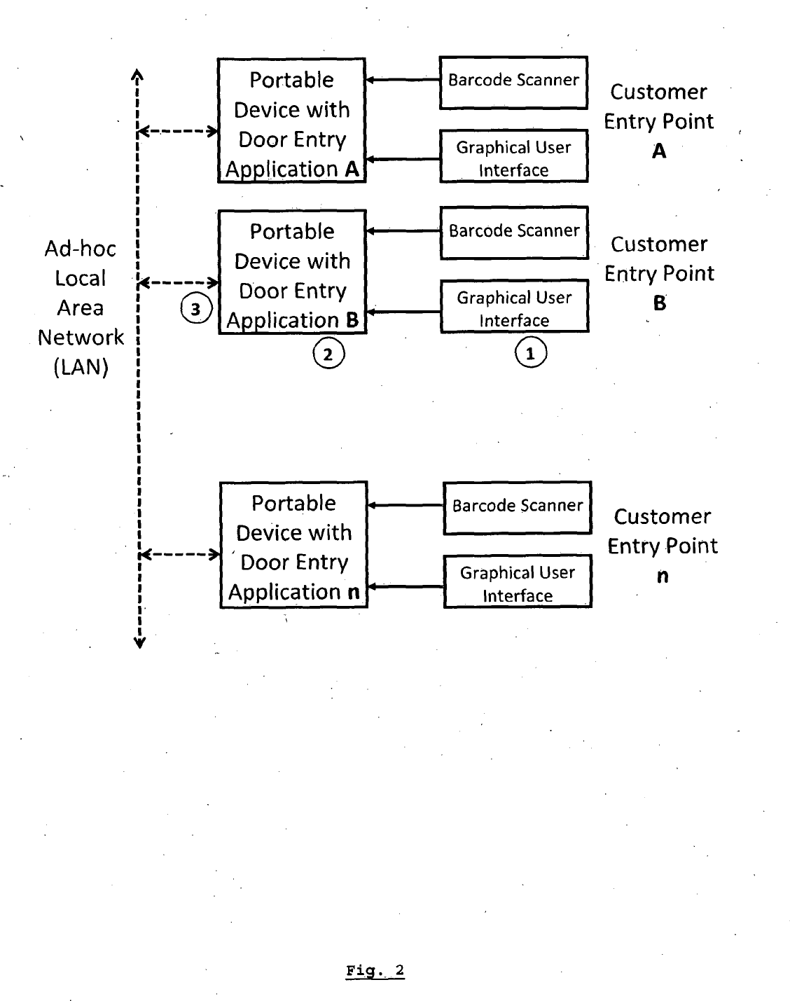

FIG. 2

\textcircled{1} A successful scan from a barcode scanner is sent to an application via'USB or a user searches for customer via GUI;

\textcircled{2} The application verifies the ticket and provides immediate feedback to user;

\textcircled{3} The application periodically poles other machines on the LAN and sends/receives updates as required.

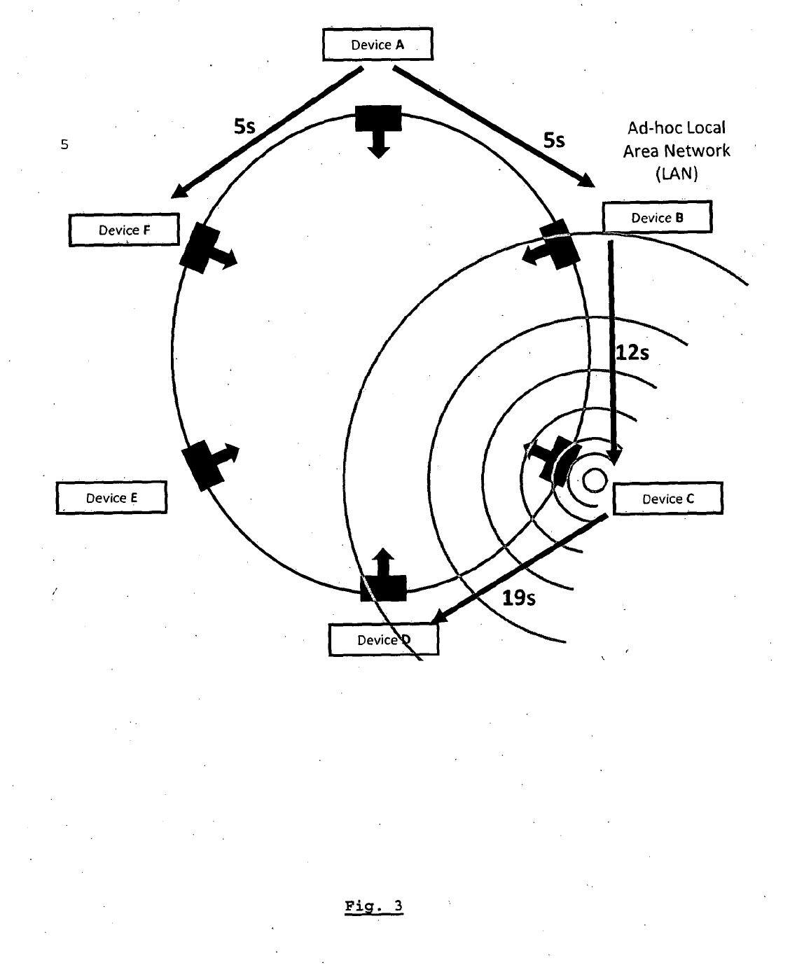

FIG. 3

All communication is push based, therefore a device reaches out to other devices sharing with them information that has happened recently. In the example of FIG. 3 the devices are using ad-hoc LAN configuration and the reach of each device is limited to 2 adjacent devices only, therefore device A can only communicate directly with device F and device B. If all devices in a network are set to 5 second updates, in the configuration in FIG. 3 it is possible for device D to be synchronised with device A in under 20 seconds. Device A pushes to device B, which then merges the data and pushes it to device C, which likewise pushes to device D.

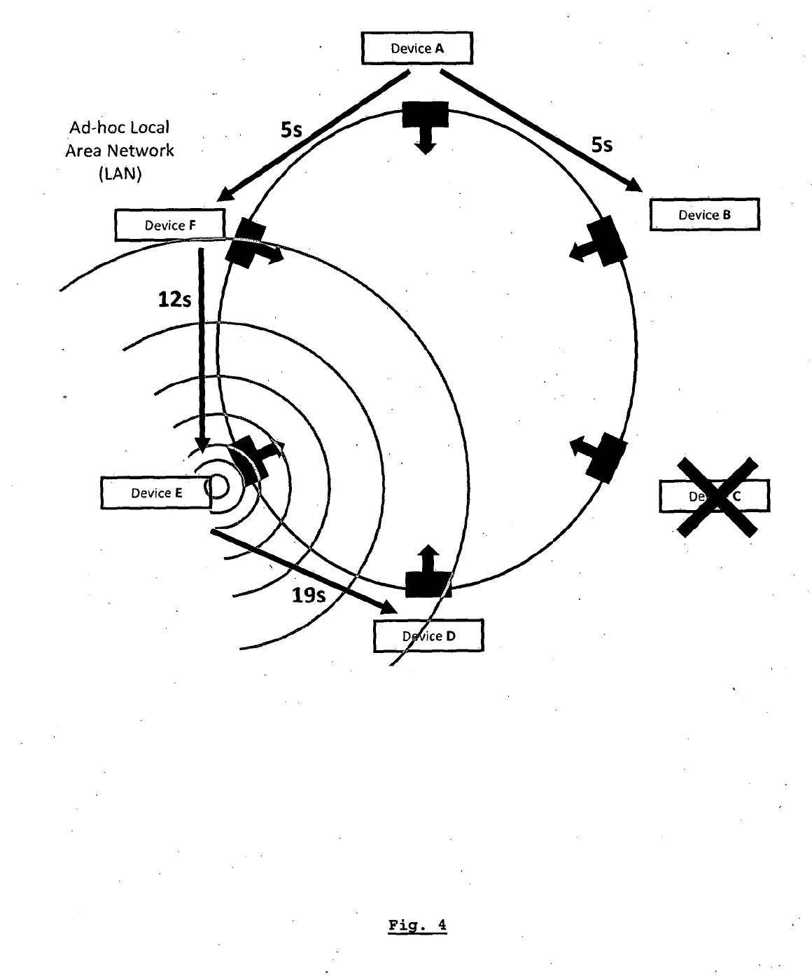

FIG. 4

If there is a failure at any point in the configuration there is no delay in the update from device A to device D because the communication will simply take a different path via device F and E respectively. Device C can then be replaced with a new unit which will instantly be updated with all events via device B or D following the ‘Discovery’ process and ‘Major Sync.’ process.

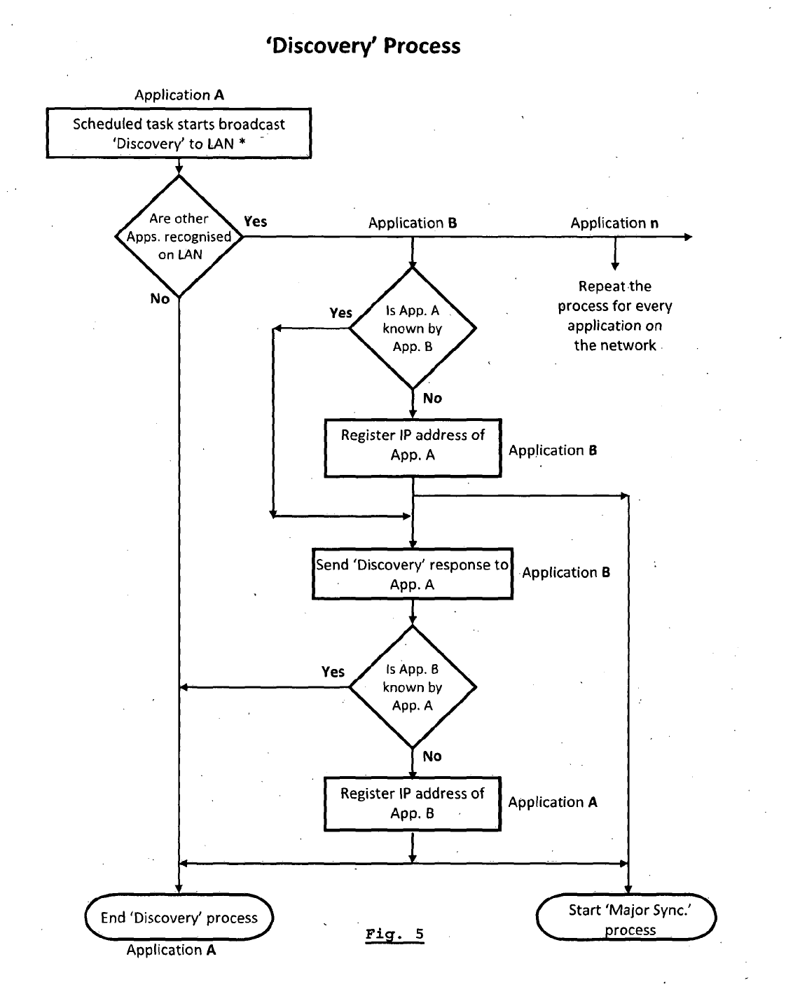

FIG. 5

Every Application performs the role of Application A at a intervals defined by the user, usually 5-10 minutes.

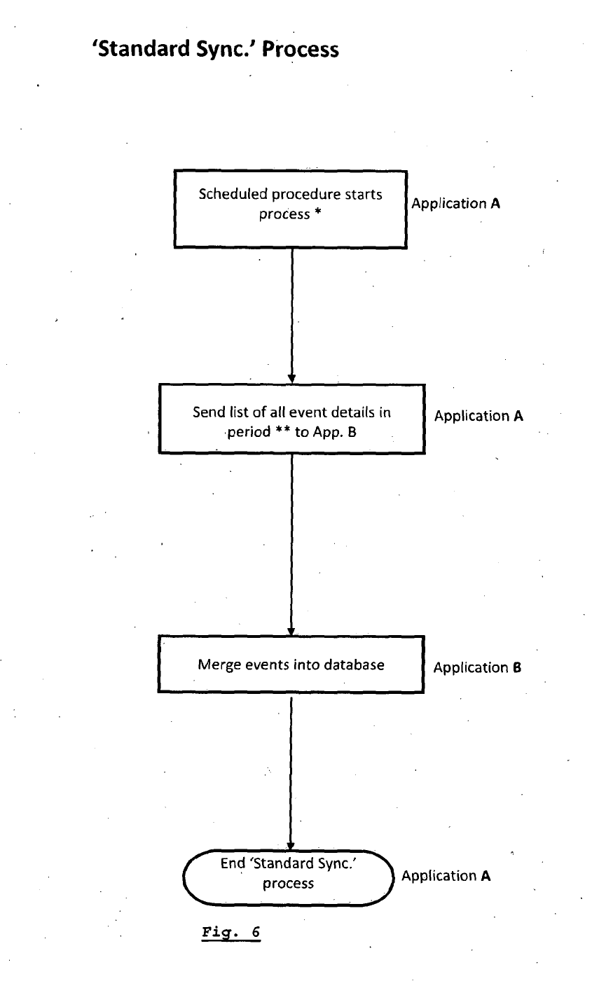

FIG. 6

Every Application performs the role of Application A at a frequency defined by the user. The frequency default is 5 seconds. This is performed in each direction between all Applications on the network.

Period is user defined, however typically 10 seconds.

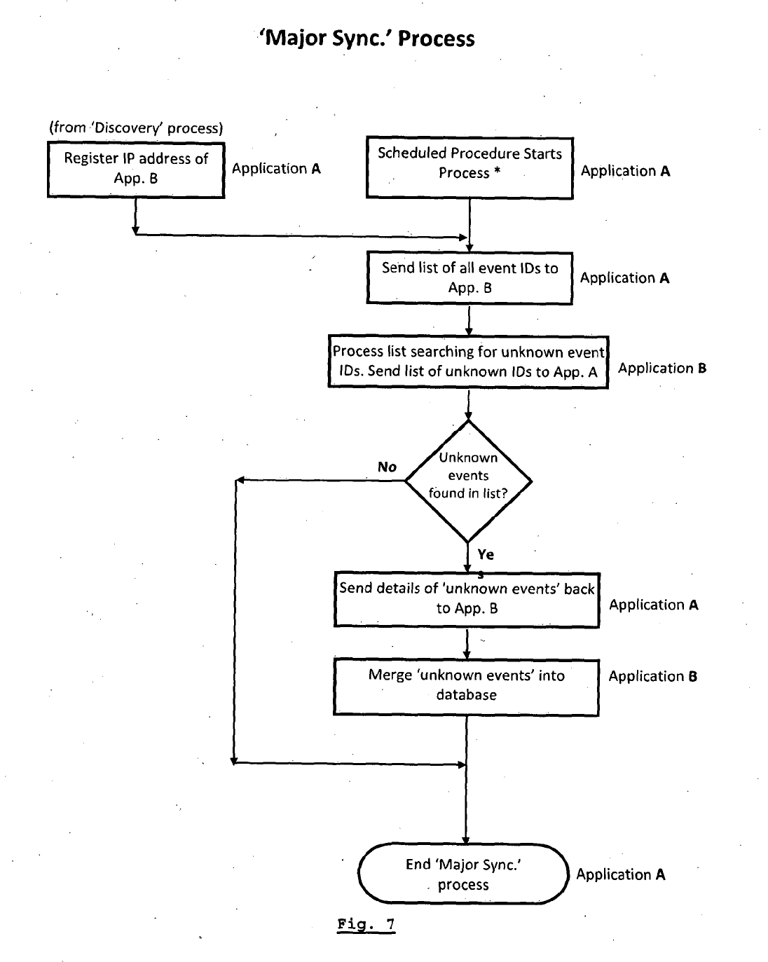

FIG. 7

Every Application performs the role of Application A at a frequency defined by the user and can also be forced to start by the user. The schedule default is 30 minutes. This is performed in each direction between all Applications on the network.

1. An access management apparatus comprising:
a ticket data input device configured to acquire ticket data from a presented ticket;
a network interface configured to communicate with one or more other ticket verification devices on a network;
data storage; and
a processor configured to:
receive ticket data from the one or more other ticket verification devices;
send received and/or acquired ticket data to the one or more other ticket verification devices;
store the acquired and/or received ticket data on the data storage; and
verify the acquired ticket data from the presented ticket by comparing it with stored valid ticket data.

2. The access management device of claim 1, wherein the ticket data input device is selected from the group consisting of: barcode reader, keyboard, camera, scanner, near field communication and RFID tag.

3. The access management device of claim 1 or claim 2, wherein the stored acquired and/or received ticket data comprises a record indicating that a ticket has been previously presented.

4. The access management device of claim 3, wherein the ticket is a multiple person entry ticket and the record further indicate the number of times that the ticket has been presented.

5. The access management device of claim 4, wherein the processor is further configured to reject the presented ticket if the acquired ticket data has been previously presented to one or more ticket verification devices a predetermined number of times.

6. The access management device according to any of claims 1 to 3, wherein the processor is further configured to reject the presented ticket if the acquired ticket data has been previously presented to one or more ticket verification devices.

7. The access management device according to any previous claim, wherein the data storage is further configured to store valid ticket data.

8. The access management device according to any previous claim, wherein the processor is further configured to reject the presented ticket if the acquired ticket data does not match valid ticket data.

9. The access management device according to any previous claim, wherein the processor is further configured to search for other ticket verification devices on the network.

10. The access management device of claim 7, wherein the processor is further configured to search at intervals.

11. The access management device according to any previous claim, wherein the processor is further configured to synchronise the stored acquired and/or received ticket data with other ticket verification devices on the network.

12. The access management device of claim 11, wherein the processor is further configured to send and receive ticket data to a subset of all ticket verification devices on the network.

13. A network of any of the access management devices of claims 1 to 12.

14. A method of managing access comprising the steps of:
acquiring ticket data from a ticket presented to a ticket verification device;
receiving ticket data from one or more other ticket verification devices on a network;
sending received and/or acquired ticket data to the one or more other ticket verification devices on the network;
storing the acquired and/or received ticket data; and
verifying the acquired ticket data from the presented ticket by comparing it with stored valid ticket data.

15. The method of claim 14, wherein the stored acquired and/or received ticket data comprises a record indicating that a ticket has been previously presented.

16. The method of claim 15, wherein the ticket is a multiple person entry ticket and the record further indicates the number of times that the ticket has been presented.

17. The method of claim 16, further comprising the step of rejecting the presented ticket if the acquired ticket data has been previously presented a predetermined number of times.

18. The method of claim 14 or claim 15 further comprising the step of rejecting the presented ticket if the acquired ticket data has been previously presented to one or more ticket verification devices.

19. The method of according to any of claims 14 to 18 further comprising the step of storing valid ticket data.

20. The method of according to any of claims 14 to 19 further comprising the step of rejecting the presented ticket if the acquired ticket data does not match valid ticket data.

21. The method of according to any of claims 14 to 120 further comprising the step of searching for other ticket verification devices on the network.

22. The method of claim 21, wherein searching occurs at intervals.

23. The method of according to any of claims 14 to 22 further comprising the step of synchronising the stored acquired and/or received ticket data with other ticket verification devices on the network.

24. The method of claim 23 further comprising the steps of sending and receiving ticket data to a subset of all ticket verification devices on the network.

25. A computer program comprising program instructions that, when executed on a computer cause the computer to perform the method of any of claims 14 to 25.

26. A computer-readable medium carrying a computer program according to claim 25.

27. A computer programmed to perform the method of any of claims 14 to 24.

28. A signal comprising the computer program of claim 25.
